(19) United States
(12) Patent Application Publication
(10) Pub. No.: US 2016/0275802 A1
(43) Pub. Date: Sep. 22, 2016

(54) UNMANNED AIRCRAFT DETECTION AND TARGETING OF OTHER AIRCRAFT FOR COLLISION AVOIDANCE

(71) Applicant: Northrop Grumman Systems Corporation, Falls Church, VA (US)

(72) Inventor: Greg S. LOEGERING, Del Mar, CA (US)

(21) Appl. No.: 14/663,824

(22) Filed: Mar. 20, 2015

(51) Int. Cl. G08G 5/04; G08G 5/00

(52) U.S. Cl. CPC G08G 5/04; G08G 5/0008; G08G 5/0078; G08G 5/0091

(57) ABSTRACT

An exemplary method is implemented by an on-board microcontroller provides collision avoidance information for unmanned vehicle systems (UAS). A first UAS sensor provides first measurements of the other in-flight aircraft facilitating a determination that the other in-flight aircraft is within a field of collision avoidance. Instructions are sent to a second UAS sensor of a type different from the type of the first sensor, where the instructions direct the second UAS sensor to attempt to detect and track the other in-flight aircraft based on location information received from the first sensor. The instructions cause the initiation of a limited field of regard scan by the second sensor. Second measurements of the other in-flight aircraft are received from the second UAS sensor. A determination that the other in-flight aircraft is within a field of collision avoidance concern is based on the both the first and second measurements. A potential collision alert and targeting information of the other in-flight aircraft is sent to an aircraft control system for a determination of whether collision avoidance maneuvering should be executed.

### BACKGROUND

This invention relates to unmanned aircraft systems (UAS) and more specifically to the automated detection and targeting of other aircraft by UAS to enable collision avoidance.

The operator of an aircraft must maintain vigilance so as to see and avoid other aircraft. For a manned aircraft this means the ability of the pilot to use the sense of sight in order to perceive a collision threat.

For a UAS, in which no pilot is aboard, complying with collision avoidance requirements will require that the UAS have the ability to detect and target other aircraft on a potential collision course and perform an avoidance maneuver if required. However, because of the limitations associated with various sensors potentially usable for detecting and targeting other approaching aircraft, a cost-effective solution has yet to be developed for UAS.

### SUMMARY

One of the objects of the present invention is to satisfy this need.

An exemplary method implemented by an on-board microcontroller provides collision avoidance information for UAS. A first UAS sensor provides first measurements of the other in-flight aircraft facilitating a determination that the other in-flight aircraft is within a field of collision avoidance. Instructions are sent to a second UAS sensor of a type different from the type of the first sensor, where the instructions direct the second UAS sensor to attempt to detect and track the other in-flight aircraft based on location information received from the first sensor. The instructions cause the initiation of a limited field of regard scan by the second sensor. Second measurements of the other in-flight aircraft are received from the second UAS sensor. A determination that the other in-flight aircraft is within a field of collision avoidance concern is based on the both the first and second measurements. A potential collision alert and targeting information of the other in-flight aircraft are sent to an aircraft control system for a determination of whether collision avoidance maneuvering should be executed.

An exemplary apparatus includes a microcontroller, coupled to first and second sensors, that executes this method based on stored program control instructions.

### DESCRIPTION OF THE DRAWINGS

Features of exemplary implementations of the invention will become apparent from the description, the claims, and the accompanying drawings in which:

FIG. 1 shows an in-flight UAS in accordance with the present invention in an environment with other aircraft.

FIG. 2 is a block diagram illustrating an embodiment of the present invention.

FIG. 3 is a flow diagram showing exemplary steps in accordance with an embodiment of the present.

### DETAILED DESCRIPTION

One aspect of the present invention resides in the inventive recognition that certain attributes of different sensors could be appropriately combined to provide a cost effective ability for an UAS to detect and target other aircraft. Although radar can measure range and range-rate of an airborne target very well, it has difficulty measuring the relative elevation and azimuth bearing with sufficient accuracy except by using a physically large antenna array. Of course, a very large antenna array is impractical for installation on most aircraft and especially a UAS. Although an electro-optical sensor (e.g. infrared sensor) can measure relative elevation and azimuth bearings quite well, these sensors cannot measure range and range-rate without specialized processing and requiring a maneuver of the aircraft carrying the sensor to change the aspect angle with regard to the target. An appreciation of the respective strengths and weaknesses of these sensors gave rise, in accordance with an aspect of the present invention, to an inventive combination of measurements made by these sensors to achieve a cost-effective mechanism for determining detection and targeting by UAS of other aircraft. Such information can be used by the aircraft control system of the UAS to make course adjustments to avoid potential collisions with other aircraft while minimizing false and/or miscalculated targeting which may result in unnecessary course adjustments or the ultimate consequence of a collision with another aircraft.

FIG. 1 shows an exemplary environment in which an in-flight UAS 105 needs to detect and target an aircraft 110 and another aircraft 115 both of which are in-flight. In this example, aircraft 110 has a heading, altitude and speed which should be detected and targeted by the UAS 105 as presenting a potential collision hazard. Alternatively, aircraft 115 has a heading, altitude and speed which should be detected and targeted by the UAS 105 as not presenting a potential collision hazard. As will be described in more detail below, the UAS 105 in accordance with an embodiment of the present invention accurately detects and targets aircraft 110 and 115 resulting in a course adjustment to avoid the potential collision course with aircraft 110 while also maintaining a safe position relative to aircraft 115.

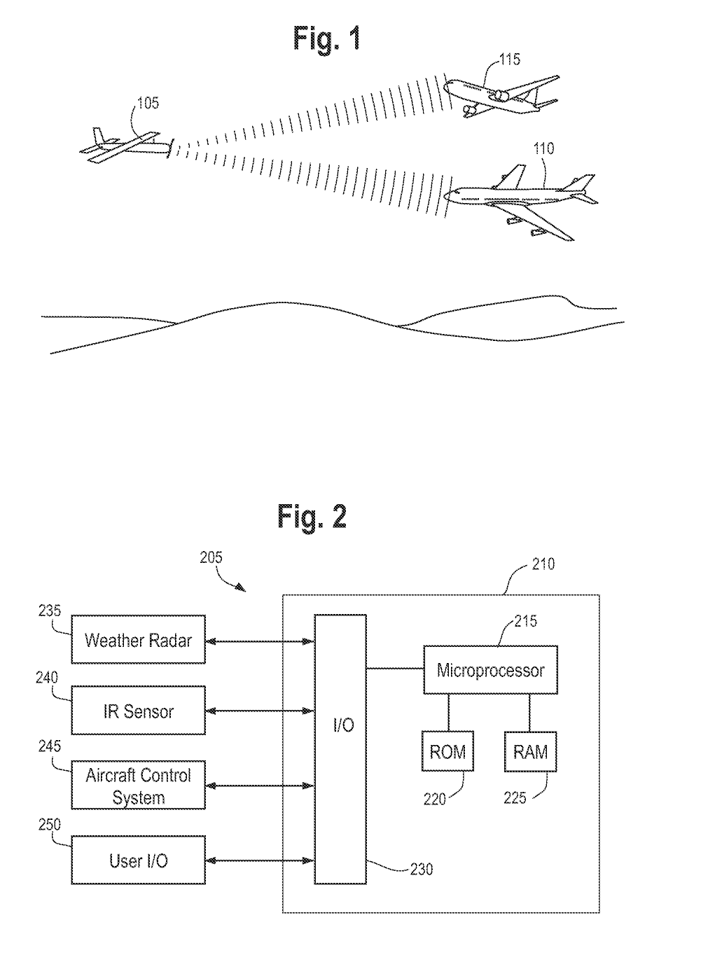

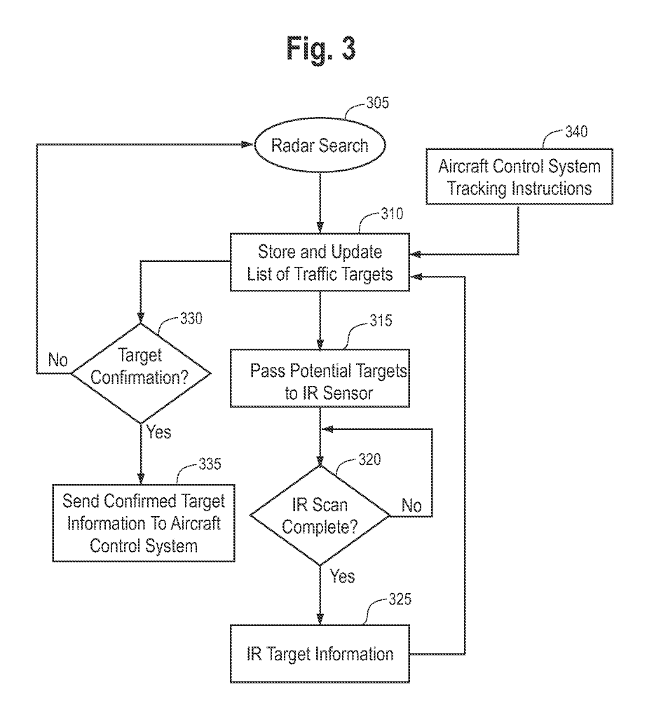

FIG. 2 shows an exemplary embodiment 205 of a detection and targeting mechanism suited for a UAS in accordance with the present invention. A microcontroller 210 includes a microprocessor 215 connected to read-only memory (ROM) 220 and random access memory (RAM) 225. As will be appreciated by those skilled in the art, ROM 220 may contain an appropriate operating system for controlling the overall operation of the microcontroller 210 and an application program that provides instructions to the microprocessor 215 for implementing the detection and targeting method as explained with regard to FIG. 3. As will be understood, at least portions of the operating system and the application program will be transferred after start up to RAM 225 for ongoing operation and processing. The RAM 225 contains additional memory capacity for storing sensor measurements as will be explained below. An input/output (I/O) interface 230 is coupled to the microprocessor 215 and provides an interface for the transfer of data between the microprocessor 215 and external sensors and/or devices.

In this exemplary embodiment, a weather radar 235 has its measurements coupled as data to the microprocessor 215 and receives control instructions from microprocessor 215. The radar preferably has a field of regard of plus or minus xxx° in azimuth and plus or minus xxx° in elevation and a range of xxx nautical miles. It preferably has a surveillance volume scan occurring at a 1 Hz rate or higher. Generally, the radar may be only able to provide a target detection at a given level of probability, e.g. 50%, for a single scan where the target is a small aircraft. In order to enhance the probability of detection, the radar may be instructed to, or may automatically, send out additional RF pulses so that a target is declared “real” only after the target is detected a number of times, e.g. 3 out of 4 attempts. By using such a repetitive technique, the probability of detection may be increased from around 50% to greater than 80%. However, utilizing too many repeated scans increases the time for a “real” target determination. Although a weather radar is used in this example, other radar units with suitable characteristics could be used.

An electro-optical sensor 240, in this exemplary implementation being an IR sensor, has its output measurements coupled as data to microprocessor 215 and receives command instructions from microprocessor 215. This sensor may, for example, be one manufactured by FLIR Systems that provides both a narrow field of view EO capable of outputting high-definition video in standard formats and a narrow field of view IR sensor. Because it has a narrow field of view and is mechanically scanned, it would not be able to survey all the volume of target space necessary at a high enough rate to provide adequate coverage of the large volume needed for initial detection of target traffic if used alone. Such a sensor may have a gimbal skew rate of 60°/second and a field of view of 2°. Based on this skew rate it would take approximately 55 seconds to scan plus and minus 110° in azimuth and plus or minus 30° in elevation. This is too slow to provide target detection capability for a sense and avoid purpose. However, as explained below, the capabilities of the IR sensor when controlled and commanded in proper combination with the sensing of the radar can provide a suitable sense and avoid mechanism for UAS.

An aircraft control system 245 is connected with the microprocessor 215 by a bidirectional data communication line. The aircraft control system 245 is responsible for the operation and control of the UAS. Typically, the UAS is controlled and operated through RF communications that couples data representing information concerning the operation of the UAS to an earth-based operator and receives command-and-control instructions for the UAS from the operator. In accordance with the embodiment of the present invention, the aircraft control system 245 sends data including the location coordinates, speed and heading of the UAS to microprocessor 215 and receives from the microprocessor 215 data representing confirmed targeting information, e.g. distance, speed, heading, of other aircraft projected to require collision avoidance by the UAS. The aircraft control system 245 may be programmed to automatically execute a collision avoidance maneuver upon receipt of the targeting information. Alternatively, the aircraft control system 245 may relay the targeting information to the operator and await collision avoidance maneuver instructions from the operator. If such instructions are not received within a predetermined time, the aircraft control system 245 may be programmed to then independently execute the collision avoidance maneuvers.

A user input/output mechanism 250 facilitates data communications to and from microprocessor 215. This allows an administrator of microcontroller 210 to provide program instructions to be stored in ROM 220 and to retrieve data stored in RAM 225. This may occur during provisioning of the microcontroller 210 on the initial installation in the UAS or during maintenance while the UAS is not airborne. Alternatively, the microcontroller can receive new or modified program instructions from the operator of the UAS via the aircraft control system or independently generated by the aircraft control system itself.

FIG. 3 is a flow diagram of exemplary steps in accordance with an embodiment of the present invention to determine possible targets of concern within a field of collision avoidance. In step 305 the radar 235 conducts its predetermined scan over its field of regard in search of potential targets. The field of collision avoidance may be based on a volume of space surrounding the projected future locations of the UAS and is triggered when another target aircraft is projected to also enter such a volume of space. The radar scanning continues until a potential target is identified. Tracking logic internal to the radar confirms the acquisition of this target, e.g. sending repetitive pulses towards the target with appropriate pulse returns being detected. In step 310 a list of traffic targets is stored, e.g. in RAM 225, and updated. The confirmed target and corresponding information, e.g. location coordinates, distance, speed, heading, etc., are received from the radar and stored. In step 315 the confirmed target and corresponding information are passed to the IR sensor 240. This causes the IR sensor to skew or reorient a narrow field of view of the IR sensor towards the target coordinates. The IR sensor is then instructed in step 320 to go into a relatively narrow search pattern, e.g. less than 10% of the maximum field of regard and preferably ±4° in both azimuth and elevation, to attempt to acquire and track this target. If this target is not detected by the IR sensor, the target is declared to be a “false” alarm and the IR sensor would return to its normal scan mode over its field of regard.

If the target is detected by the IR sensor during its scan, the target is validated as a potential collision avoidance threat. Upon completion of the scan attempt by the IR sensor to acquire the potential target identified by the radar, the target information determined by the IR sensor as indicated at step 325 is transferred to and updates the list of traffic targets indicated at step 310. Thus the target confirmed by the radar has now been validated by a concurring validation by the IR sensor. In step 330 a determination is made of whether a target confirmation has been made and confirmed by both the IR and radar sensors. A NO determination at step 330 causes a continuation of scanning for potential targets by the radar search at step 305. A YES determination by step 330, indicating concurring target validation by both the radar and IR sensors, results in step 335 sending a potential collision alert and the confirmed target information to the aircraft control system for implementation of a collision avoidance protocol. The potential collision alert may simply be the receipt of confirmed target information by the aircraft control system as opposed to a separate alert signal. Preferably, the target information sent to the aircraft control system includes all of the relevant most current information associated with the target, e.g. location coordinates, speed, heading, etc. In step 340 the aircraft control system sends tracking instructions to update the list associated with step 310. As long as a target reported in step 335 is determined to be a continuing potential collision avoidance threat by the aircraft control system, instructions are sent in step 340 to maintain this target in the list as a continuing possible threat causing the sensors to continue to track this target. When the aircraft control system determines a reported target as to longer being a collision avoidance threat based on continuing received tracking information, instructions are sent in step 340 to disregard the associated target in the list causing the sensors to resume a normal field of regard scan protocol. The stored list associated with step 310 may consist of a table in which a row is associated with a particular target with multiple columns containing stored and updated tracking information from the radar and IR sensor, and instructions from the aircraft control system. Alternatively, the list may consist of multiple vectors in which predetermined fields store and maintain updated information.

Although exemplary implementations of the invention have been depicted and described in detail herein, it will be apparent to those skilled in the art that various modifications, additions, substitutions, and the like can be made without departing from the spirit of the invention. For example, the exemplary microcontroller could be incorporated into the aircraft control system with the illustrative steps implemented by the aircraft control system. The EO/IR sensor could be replaced by another sensor having complementary characteristics to the exemplary weather radar, i.e. the ability to scan a selected much smaller subset of the field of regard while providing accurate measurements of the parameters for which the exemplary weather radar has limitations, e.g. relative elevation and azimuth measurements. Alternatively, the exemplary weather radar could be replaced by a different sensor having complementary characteristics to the exemplary EO/IR sensor, i.e. the ability to scan a relatively large field of regard within a relatively short time while providing accurate measurements of the parameters for which the exemplary EO/IR sensor has limitations, e.g. relative range and range-rate measurements. The illustrative steps could be executed in a different order and some steps omitted or other steps added as long as the end objective of providing targeting information for collision avoidance action is satisfied.

The scope of the invention is defined in the following claims.

1. An apparatus provides on-board collision avoidance information for unmanned vehicle systems (UAS) comprising:
a microcontroller operating under stored program instructions disposed on the UAS;
a first sensor disposed on the UAS of one type detects and tracks other in-flight aircraft, the first sensor sending first measurements of the other in-flight aircraft to the microcontroller;
a second sensor disposed on the UAS of a type different from the one type for detecting and tracking other in-flight aircraft;
the microcontroller, upon determining the first measurements representing the other in-flight aircraft is within a field of collision avoidance, sends instructions to the second sensor causing it to attempt to detect and track the other in-flight aircraft based on location information of the other in-flight aircraft received from the first sensor;
the microcontroller, upon receiving second measurements from the second sensor representing the results of a scan by the second sensor to detect and track the other in-flight aircraft, determines based on the first and second measurements the other in-flight aircraft is within the field of collision avoidance, and sends a potential collision alert and targeting information of the other in-flight aircraft to an aircraft control system for a determination of whether collision avoidance maneuvering by the UAS should be executed.

2. The apparatus of claim 1 wherein the first sensor comprises a radar unit.

3. The apparatus of claim 2 wherein the radar unit is a weather radar.

4. The apparatus of claim 1 wherein the second sensor is an electro-optical sensor.

5. The apparatus of claim 1 wherein the second sensor, upon receipt of instructions from the microcontroller containing location information of the other in-flight aircraft, employs a limited field of regard scan oriented to said location information of the other in-flight aircraft, the limited field of regard scan being less than 10% of the total field of regard scan for which the second sensor is capable.

6. The apparatus of claim 1 wherein the microcontroller includes memory in which the first and second measurements are stored, the microcontroller sending the potential collision alert and targeting information only when both the first and second measurements for a certain in-flight aircraft indicate that the latter is within a field of collision avoidance.

7. The apparatus of claim 1 wherein the microcontroller includes memory in which the first and second measurements are stored, the microcontroller not sending the potential collision alert and targeting information when only one of the first and second measurements for a certain in-flight aircraft indicate that the latter is within a field of collision avoidance.

8. A method implemented by an on-board microcontroller provides collision avoidance information for unmanned vehicle systems (UAS) comprising the steps of:
receiving from a first UAS sensor first measurements of the other in-flight aircraft;
determining that the other in-flight aircraft is within a field of collision avoidance based on the first measurements;
sending instructions to a second UAS sensor of a type different from the type of the first sensor, the instructions directing the second UAS sensor to attempt to detect and track the other in-flight aircraft based on location information of the other in-flight aircraft received from the first sensor;
the instructions causing the initiation of a field of regard scan by the second sensor where the field of regard scan is limited to less than 10% of the second sensor's maximum field of regard scan and oriented to location information determined by the first sensor;
receiving from the second UAS sensor second measurements of the other in-flight aircraft;
determining that the other in-flight aircraft is within a field of collision avoidance concern based on the both the first and second measurements;
sending a potential collision alert and targeting information of the other in-flight aircraft to an aircraft control system for a determination of whether collision avoidance maneuvering should be executed.

9. The method of claim 8 wherein the first measurements are received from a radar unit.

10. The method of claim 9 wherein the radar unit is a weather radar.

11. The method of claim 8 wherein the second measurements are received from an electro-optical sensor.

12. The method of claim 8 further comprising storing the first and second measurements in memory, the potential collision alert and targeting information being sent only when both the first and second measurements for a certain in-flight aircraft indicate that the latter is within a field of collision avoidance.

13. The method of claim 8 further comprising storing the first and second measurements in memory, the potential collision alert and targeting information are not sent when only one of the first and second measurements for a certain in-flight aircraft indicate that the latter is within a field of collision avoidance.
